(19) United States
(12) Patent Application Publication
(10) Pub. No.: US 2007/0201367 A1
(43) Pub. Date: Aug. 30, 2007

(54) System and method for interworking H.323 flow control with SIP

(75) Inventors: Yun-Chung Chen, Fremont, CA (US); Paul E. Jones, Apex, NC (US); John K. Restrick JR., Palo Alto, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/364,708

(22) Filed: Feb. 27, 2006

(51) Int. Cl. H04J 1/16; H04J 3/16

(52) U.S. Cl. 370/235; 370/469

(57) ABSTRACT

A system and method are provided for controlling a transfer rate between a first endpoint and a second endpoint, wherein the first endpoint implements a first protocol and the second endpoint implements a second protocol. The system and method may comprise elements for receiving a first control message from the first endpoint, wherein the first control message conforms to the first protocol and comprises instructions for adjusting the transfer rate to a designated bandwidth; generating a second control message that conforms to the second protocol and comprises instructions for adjusting the transfer rate to the designated bandwidth; and sending the second control message to the second endpoint.

### BACKGROUND OF THE INVENTION

The field of communications has become increasingly important in today's society. In particular, the ability to quickly and effectively interact with an individual (through any suitable communications media) presents a significant obstacle for component manufacturers, system designers, and network operators. This obstacle is made even more difficult due to the plethora of diverse communication technologies that exist in the current marketplace.

As new communication architectures (such as the Session Initiation Protocol (SIP) and the Voice over Internet Protocol (VoIP)) become available to the consumer, new processes need to be developed in order to optimize this emerging technology. Interoperability between architectures and protocols is particularly important to the development of advanced communication systems. One example of the necessity for such interoperability is demonstrated in video conferencing. SIP-enabled devices and H.323 devices both support video conferencing, but currently have limited or no interoperability. In H.323 and H.320 video conferencing, for instance, a common operation is to send a message to an endpoint to tell it to change its video transmit rate. Common reasons for adjusting the video transmit rate include preventing overflow in ISDN Gateways (which have a fixed bandwidth), and to match video rates between devices so that they do not have to transrate the video (which may requires significant computing resources). H.323 provides various mechanisms for flow control, but SIP has no directly analogous mechanism. Thus, in order to deliver a sustainable product that can compete with conventional architectures, SIP developers need a means for enabling flow control to support video conferencing capabilities with H.323 devices.

### SUMMARY OF THE INVENTION

In accordance with the present invention, disadvantages and problems associated with interoperability of communications between disparate architectures have been substantially reduced or eliminated. In particular, the present invention greatly reduces problems associated with flow control of video conferencing between disparate architectures.

In accordance with one embodiment of the present invention, a method is provided for controlling a transfer rate between a first endpoint and a second endpoint, wherein the first endpoint implements a first protocol and the second endpoint implements a second protocol. In such an embodiment, the method comprises receiving a first control message from the first endpoint, wherein the first control message conforms to the first protocol and comprises instructions for adjusting the transfer rate to a designated bandwidth; generating a second control message that conforms to the second protocol and comprises instructions for adjusting the transfer rate to the designated bandwidth; and sending the second control message to the second endpoint.

In accordance with another embodiment of the present invention, a system is provided for controlling a transfer rate between a first endpoint and a second endpoint, wherein the first endpoint implements a first protocol and the second endpoint implements a second protocol. In such an embodiment, the system comprises a receiver component operable to receive a first control message from the first endpoint, wherein the first control message conforms to the first protocol and comprises instructions for adjusting the transfer rate to a designated bandwidth; a processor component operable to generate a second control message that conforms to the second protocol and comprises instructions for adjusting the transfer rate to the designated bandwidth; and a transmitter component operable to send the second control message to the second endpoint.

Important technical advantages of certain embodiments of the present invention include the interoperability of existing H.323 endpoints with SEP endpoints, especially in environments with non-transrating MCUs and ISDN gateways, and the ability of call agents to use flow control for purposes of bandwidth policy.

Other technical advantages of the present invention may be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 is a simplified block diagram of a communication system for exchanging data in accordance with certain teachings of the present invention; and

FIG. 2 is a simplified call diagram that illustrates an example operation of an embodiment of the present invention.

### DETAILED DESCRIPTION OF THE INVENTION

The H.323 protocol provides various mechanisms for flow control during a communication session, such as a video conference. One H.323 mechanism that provides flow control is the H.245 FlowControlCommand message. An Open Logical Channel Acknowledgment (OLCAck) message may provide an alternative flow control mechanism. SIP, however, provides no directly analogous flow control messages. In order for SIP and H.323 endpoints to participate in video calls with each other, a SIP-to-H.323 gateway must interwork the two different types of signaling to provide equivalent video flow control.

For purposes of teaching and discussion, it is useful to provide an overview of a communication system in which certain features of the present invention may be implemented. The following foundational information may be viewed as a basis from which the present invention may be properly explained. Such information is offered earnestly for purposes of explanation only and, accordingly, should not be construed in any way to limit the broad scope of the present invention and its potential applications.

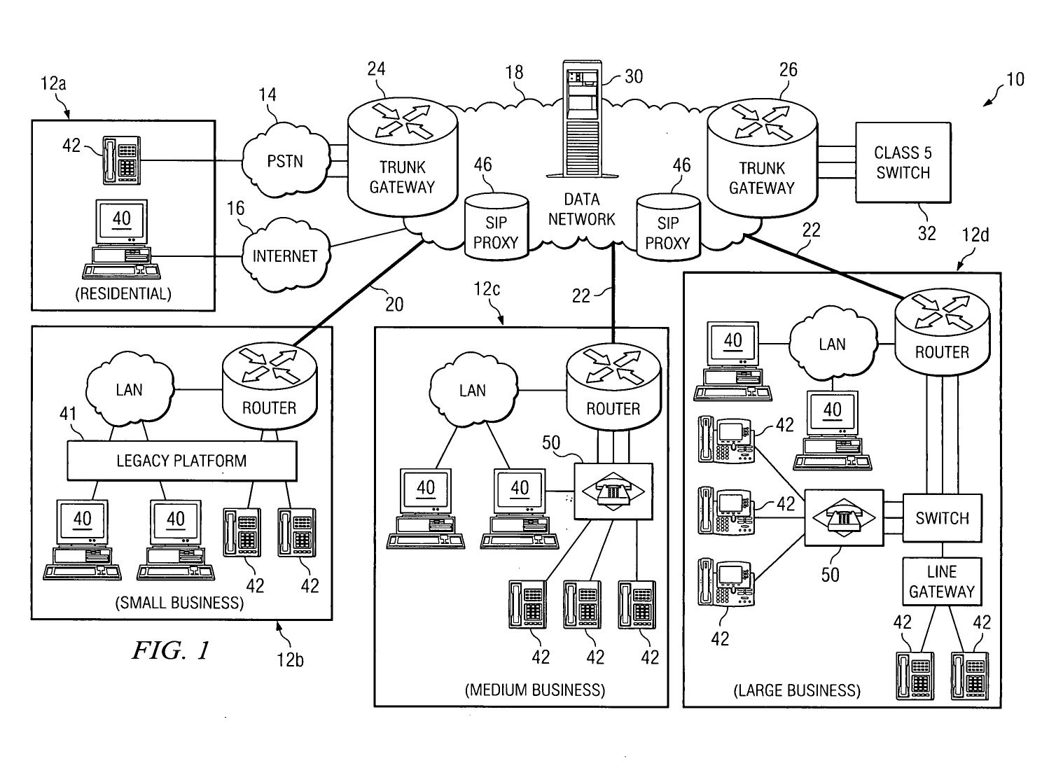

FIG. 1 is a simplified block diagram of a communication system 10 for exchanging data in accordance with certain teachings of the present invention. Communication system 10 includes domains 12a-12d, a public switched telephone network (PSTN) 14, a wide-area network 16 (such as the Internet), a data network 18, a broadband access link 20, and a number of additional links 22. Additional links 22 may include, for example, a digital subscriber line (DSL) link, a T1 link, a fiber optic link, or a wireless link. Communication system 10 also includes a set of trunk gateways 24 and 26, a third-party application server 30, and a Class-5 switch 32.

Each domain may include suitable network equipment and appropriate infrastructure (e.g., switches, routers, LANs, gateways, etc.) to facilitate a SIP session. Domain 12a represents a residential location, which consists of a computer 40 and a telephone 42. Telephone 42 may be an Internet protocol (IP) telephone or a standard telephone operable to interface with computer 40 such that one or more calling capabilities are enabled through telephone 42. Accordingly, two types of telephones are illustrated in FIG. 1. Domain 12b represents a small business entity, which consists of a local area network (LAN), a router, several computers 40, and several telephones 42. In addition, domain 12b may include a legacy platform 41, which is operable to communicate with each telephone 42 and/or computer 40.

Domain 12c represents a medium business entity, which consists of a LAN, router, a private branch exchange (PBX) or key system, several computers 40, and several telephones 42. Domain 12d is a large business entity, which consists of a LAN, a router, a switch, a line gateway, several computers 40, and several telephones 42. Note that domains 12c and 12d each include a communications platform 50, which is operable to communicate with any number of “endpoints” (e.g., telephones 42 and/or computer 40). In one embodiment, communications platform 50 is a Call Manager element, which is manufactured by Cisco Systems, Inc. of San Jose, Calif. In other embodiments, communications platform 50 may be any suitable unit operable to interface with end-user devices (e.g., telephone 42, computer 40, etc.).

Note that the term “endpoint” encompasses a myriad of potential devices and infrastructure that may benefit from the operations of communication system 10. Endpoints may represent a personal digital assistant (PDA), a cellular telephone, a standard telephone (which may be coupled to a personal computer), an IP telephone, a personal computer, a laptop computer, a mobile telephone, or any other suitable device or element (or any appropriate combination of these elements) that is operable to receive data or information. FIG. 1 illustrates only one set of example devices that may be used within communication system 10. The present invention is replete with numerous alternatives that could be used to facilitate the operations of communication system 10.

It should also be noted that the internal structure of the endpoints are malleable and can be readily changed, modified, rearranged, or reconfigured in order to achieve their intended operations, as they pertain to the flow control feature. Note also that the endpoints can each include a link to communications platform 50, which is operable to communicate with any number of endpoints/user agents/devices. As indicated above, in one embodiment, communications platform 50 is a Call Manager element, which is manufactured by Cisco Systems, Inc. of San Jose, Calif. The Call Manager element is SIP-enabled, and it can readily accommodate other protocols (e.g., H.323). In other embodiments, communications platform 50 is any suitable component (e.g. a gateway, a switch, a router, a bridge, a state machine, a processor, etc.) that is operable to interface with endpoints/end-users.

As outlined above, software and/or hardware may reside in communications platform 50 in order to achieve the teachings of the flow control feature of the present invention, as outlined herein. However, due to its flexibility, communications platform 50 may alternatively be equipped with (or include) any suitable component, device, application specific integrated circuit (ASIC), processor, microprocessor, algorithm, read-only memory (ROM) element, random access memory (RAM) element, erasable programmable ROM (EPROM), electrically erasable programmable ROM (EEPROM), field-programmable gate array (FPGA), or any other suitable element or object that is operable to facilitate the operations thereof. Considerable flexibility is provided by the structure of communications platform 50 in the context of communication system 10 and, accordingly, it should be construed as such.

Endpoints in communication system 10 implement various communication protocols, which may include the Session Initiation Protocol (SIP) and the H.323 protocol. As used herein, then, the term “SIP endpoint” refers to any endpoint that implements the SIP protocol, and the term “H.323 endpoint” refers to any endpoint that implements the H.323 protocol.

For purposes of teaching and discussion, it is also useful to provide a more detailed view of SIP operations in an environment such as communication system 10. Again, the following information may be viewed as a basis from which the present invention may be properly explained. Such information is offered earnestly for purposes of explanation only and, accordingly, should not be construed in any way to limit the broad scope of the present invention and its potential applications.

SIP is an application-layer control protocol that can establish, modify, and terminate multimedia sessions (conferences) such as Internet telephony calls. SIP can also invite participants to already existing sessions, such as multicast conferences. Media can be added to (and removed from) an existing session. To an end user, SIP transparently supports name mapping and redirection services, which supports personal mobility. End users can maintain a single externally visible identifier regardless of their network location.

In general, SIP supports five facets of establishing and terminating multimedia communications: 1) user location (determining the end system to be used for communication); 2) user availability (determining the willingness of the called party to engage in communications); 3) user capabilities (determining the media and media parameters to be used); 4) session setup (“ringing” and establishment of session parameters at both called and calling party locations); and 5) session management (including transfer and termination of sessions, modifying session parameters, and invoking services).

A standard SIP platform does not provide services. Rather, SIP provides primitives that can be used to implement different services. For example, SIP can locate a user and deliver an opaque object to his current location. If this primitive is used to deliver a session description conforming to the Session Description Protocol (SDP), for instance, the endpoints can agree on the parameters of a session. SIP can function with SOAP, HTTP, XML, SDP, and a variety of other protocols to implement services.

Endpoints in a SIP environment communicate by exchanging messages, which may be either a “request” or a “response.” Generally, an endpoint (also sometimes referred to as a “user agent” or “UA” in a SIP environment) operates as either a User Agent Client (UAC) or a User Agent Server (UAS), although a single endpoint can (and often does) operate as both a UAC and a UAS. A UAC generates requests and sends them to one or more UASs. A SIP proxy, such as SIP proxy 46 in FIG. 1, often facilitates message exchanges between SIP endpoints. A UAS receives requests, processes them, and sends responses.

Each message (requests and responses) includes a header comprising one or more header fields. For example, many SIP headers include a “To:” header field and a “From:” header field. In turn, each header field may comprise one or more parameters that convey information about the message or, more generally, about a given session.

In certain embodiments of the present invention, a gateway translates control messages from endpoints that implement disparate protocols. For instance, the gateway may translate an H.245 FlowControlCommand message to a SIP re-INVITE request with an embedded SDP payload (or attachment), or vice versa. Such a gateway may be implemented as an independent physical or logical element in communication system 10, or may be integrated into another element, such as communication platform 50 or any other form of call agent, feature server, protocol gateway, session border controller, or the like. In the re-INVITE, the previous session is offered but with the bit rate of the video stream modified based on the FlowControlCommand message. H.323 flow control operations are often asymmetric, with transmit and receive rates controlled independently. However, SDP generally negotiates symmetric media flows on one line (an m-line), which results in symmetric control. Audio rates also are usually negotiated symmetrically on a single, but distinct, m-line. In this case the rate modification will be for both transmit and receive. Consequently, the gateway also should send a FlowControlCommand message back to the originator, indicating that the originator should adjust its transmit rate as well. Generally, though, reducing bandwidth bi-directionally does not create a bottleneck. For instance, if the objective of the FlowControlCommand message is to avoid an overflow, the reverse rate probably needs to be reduced anyway.

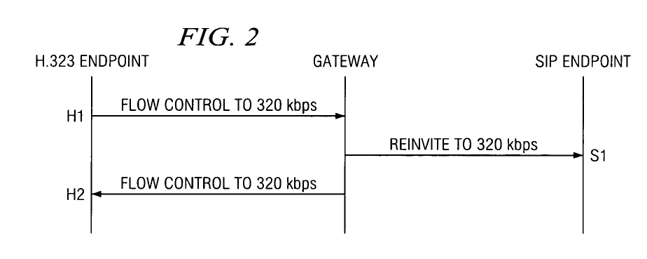

FIG. 2 is a simplified call diagram that illustrates an example operation of an embodiment of the present invention. In FIG. 2, the gateway receives a FlowControlCommand message (H1) from an H.323 endpoint, indicating that the SIP endpoint should adjust its transmit rate to 320 kbps. In accordance with certain teachings of the present invention, the gateway then generates a SIP re-INVITE request having an embedded session description that sets the transfer rate to 320 kbps, and sends the message (S1) to the SIP endpoint. If the SIP endpoint accepts the SDP, it will adjust both the transmit rate and the receive rate. Accordingly, the gateway generates a second FlowControlCommand message (H2) specifying an identical transmit rate for the H.323 endpoint, and send the message to the H.323 endpoint. Similarly, re-INVITEs received from a SIP endpoint may be mapped to FlowControlCommand messages if the only session change is a bandwidth modification.

Alternatively, the gateway may receive a flow control instruction from an H.323 endpoint via an OLCAck message. Such an instruction may be manifested as a FlowControltoZero value set to TRUE in an OLCAck message. In accordance with certain teachings of the present invention, then, such a message would be treated substantially the same as a FlowControlCommand message with a bandwidth of zero (0).

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

For instance, in other embodiments, SDP may specify transmit and receive rates on different m-lines, and the gateway may omit the reverse flow control message (H2 in FIG. 2) since the semantics are more closely matched. Yet other embodiments may also recognize that a FlowControlCommand message specifying a rate of zero (0) is a special case in which a gateway may map the FlowControlCommand message to a re-INVITE with an SDP that specifies an m-line mode value of inactive or send only.

Moreover, there are numerous ways to specify a particular transfer rate in SDP. For instance, the bandwidth may be specified on a b-line using a TIAS modifier, a CT modifier, or an AS modifier. Alternatively, a MAXBR parameter may be specified on an a-line with an ftmp attribute, which may provide backward compatibility with prior SDP implementations. While several specific methods of specifying a transfer rate in SDP have been identified here, such methods are presented for purposes of teaching only. The principles discussed herein are not limited to any particular method of specifying bandwidth.

What is claimed is:

1. A method for controlling a transfer rate between a first endpoint and a second endpoint, wherein the first endpoint implements a first protocol and the second endpoint implements a second protocol, the method comprising:
receiving a first control message from the first endpoint, wherein the first control message conforms to the first protocol and comprises instructions for adjusting the transfer rate to a designated bandwidth;
generating a second control message that conforms to the second protocol and comprises instructions for adjusting the transfer rate to the designated bandwidth; and
sending the second control message to the second endpoint.

2. The method of claim 1, wherein the instructions of the first control message comprise instructions for adjusting the transfer rate for a first stream direction; and further comprising sending a third control message to the first endpoint that conforms to the first protocol and comprises instructions for adjusting the transfer rate for a second stream direction that is opposite the first stream direction.

3. The method of claim 2, wherein the first protocol is an H.323 protocol;
wherein the second protocol is a Session Initiation Protocol; and wherein the second control message carries the instructions in a session description.

4. The method of claim 1, wherein the second control message carries the instructions in a session description.

5. The method of claim 1, wherein the designated bandwidth is zero; and wherein the instructions of the second control message comprise a session description that specifies an inactive mode.

6. The method of claim 1, wherein the designated bandwidth is zero; and wherein the instructions of the second control message comprise a session description that specifies a send-only mode.

7. The method of claim 2, wherein the first protocol is a Session Initiation Protocol; wherein the second protocol is an H.323 protocol; and wherein the first control message carries the instructions in a session description.

8. A system for controlling a transfer rate between a first endpoint and a second endpoint, wherein the first endpoint implements a first protocol and the second endpoint implements a second protocol, the system comprising:
a receiver component operable to receive a first control message from the first endpoint, wherein the first control message conforms to the first protocol and comprises instructions for adjusting the transfer rate to a designated bandwidth;
a processor component operable to generate a second control message that conforms to the second protocol and comprises instructions for adjusting the transfer rate to the designated bandwidth; and
a transmitter component operable to send the second control message to the second endpoint.

9. The system of claim 8, wherein the instructions of the first control message comprise instructions for adjusting the transfer rate for a first stream direction; and wherein the transmitter component is further operable to send a third control message to the first endpoint that conforms to the first protocol and comprises instructions for adjusting the transfer rate for a second stream direction that is opposite the first stream direction.

10. The system of claim 9, wherein the first protocol is an H.323 protocol; wherein the second protocol is a Session Initiation Protocol; and wherein the second control message carries the instructions in a session description.

11. The system of claim 8, wherein the second control message carries the instructions in a session description.

12. The system of claim 8, wherein the designated bandwidth is zero; and wherein the instructions of the second control message comprise a session description that specifies an inactive mode.

13. The system of claim 8, wherein the designated bandwidth is zero; and wherein the instructions of the second control message comprise a session description that specifies a send-only mode.

14. The system of claim 9, wherein the first protocol is a Session Initiation Protocol; wherein the second protocol is an H.323 protocol; and wherein the first control message carries the instructions in a session description.

15. Software encoded in a computer-readable medium comprising computer code such that when executed is operable to:
receive a first control message from a first endpoint that implements a first protocol, wherein the first control message conforms to the first protocol and comprises instructions for adjusting a transfer rate to a designated bandwidth;
generate a second control message that conforms to a second protocol and comprises instructions for adjusting the transfer rate to the designated bandwidth; and
send the second control message to a second endpoint that implements the second protocol.

16. The software of claim 15, wherein the instructions of the first control message comprise instructions for adjusting the transfer rate for a first stream direction; and wherein the computer code is further operable to send a third control message to the first endpoint that conforms to the first protocol and comprises instructions for adjusting the transfer rate for a second stream direction that is opposite the first stream direction.

17. The software of claim 16, wherein the first protocol is an H.323 protocol; wherein the second protocol is a Session Initiation Protocol; and wherein the second control message carries the instructions in a session description.

18. The software of claim 15, wherein the second control message carries the instructions in a session description.

19. The software of claim 15, wherein the designated bandwidth is zero; and wherein the instructions of the second control message comprise a session description that specifies an inactive mode.

20. The software of claim 15, wherein the designated bandwidth is zero; and wherein the instructions of the second control message comprise a session description that specifies a send-only mode.

21. The software of claim 16, wherein the first protocol is a Session Initiation Protocol; wherein the second protocol is an H.323 protocol; and wherein the first control message carries the instructions in a session description.

22. A system for controlling a transfer rate between a first endpoint and a second endpoint, wherein the first endpoint implements a first protocol and the second endpoint implements a second protocol, the system comprising:
means for receiving a first control message from the first endpoint, wherein the first control message conforms to the first protocol and comprises instructions for adjusting the transfer rate to a designated bandwidth;
means for generating a second control message that conforms to the second protocol and comprises instructions for adjusting the transfer rate to the designated bandwidth; and
means for sending the second control message to the second endpoint.
